(19) United States
(12) Patent Application Publication
(10) Pub. No.: US 2016/0027092 A1
(43) Pub. Date: Jan. 28, 2016

(54) TECHNIQUES FOR SELLING AND PURCHASING PRODUCTS VIA SYNCHRONOUS TWO-WAY ELECTRONIC COMMUNICATION SESSIONS

(71) Applicant: Google Inc., Mountain View, CA (US)

(72) Inventor: Richard Farmer, Seattle, WA (US)

(73) Assignee: Google Inc., Mountain View, CA (US)

(21) Appl. No.: 14/444,232

(22) Filed: Jul. 28, 2014

(51) Int. Cl. G06Q 30/06; G06Q 50/00; H04L 29/08; G06Q 30/02

(52) U.S. Cl. CPC G06Q 30/0635; G06Q 30/0257; G06Q 50/01; H04L 67/10

(57) ABSTRACT

A computer-implemented technique includes initiating a synchronous two-way electronic communication session between consumer and vendor computing devices. This synchronous two-way electronic communication session may be initiated once the consumer passively or explicitly opts-in. The vendor provides an offer to purchase a product from their vendor computing device to the consumer computing device, and the consumer can ask follow-up questions and, if satisfied with the offer, purchase the product via their consumer computing device. The consumer's acceptance can be a one-click input to the consumer computing device, such as selecting a unique link associated with the offer, which can initiate a purchase process, such as a one-click purchase process. The purchase process can involve transmitting purchase information directly to the vendor computing device from the consumer computing device, or transmitting authentication information to a third-party payment service, such as one associated with an electronic wallet, which can then pay the vendor.

### FIELD

The present disclosure generally relates to real-time electronic communications and, more particularly, to techniques for selling and purchasing products via synchronous two-way electronic communication sessions.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

The purchase of products via a computing device, also known as “online shopping,” can be difficult and/or time consuming, both for the consumers (the buyers) and the vendors (the sellers). For the vendors, for example, it can be difficult and/or expensive to create a website to offer their products for sale. For the consumers, for example, it can be difficult and/or time consuming to browse the website and to make purchase decisions without any human interaction (e.g., to answer questions). Email marketing techniques are not in real-time and thus may be inadequate for consumers seeking real-time feedback from the vendors. Thus, conventional online shopping systems fail to make the online shopping experience easy and/or efficient for both the consumers and the vendors.

### SUMMARY

A computer-implemented technique is presented. The technique can include receiving, at a consumer computing device having one or more processors, an input from a consumer associated with the consumer computing device, the input being indicative of a request to follow a vendor on a social network. The technique can include transmitting, from the consumer computing device to a server associated with the social network, the request, wherein receipt of the request causes the server to notify a vendor computing device associated with the vendor that the consumer has opted-in to receiving offers for products associated with the vendor via a synchronous two-way electronic communication session. The technique can include joining, by the consumer computing device, the synchronous two-way electronic communication session with the vendor computing device. The technique can include receiving, at the consumer computing device from the vendor computing device via the synchronous two-way electronic communication session, an offer to purchase a specific product associated with the vendor. The technique can include displaying, at the consumer computing device, the offer to purchase the specific product within the synchronous two-way electronic communication session. The technique can include receiving, at the consumer computing device, a one-click input from the consumer indicating an acceptance of the offer to purchase the specific product from the vendor. The technique can also include in response to receiving the one-click input, transmitting, from the consumer computing device to a third-party payment service, purchase information for the consumer, wherein receipt of the purchase information at the third-party payment service causes the third-party payment service to pay the vendor thereby completing the sale of the specific product to the consumer.

Another computer-implemented technique is also presented. The technique can include joining, by a consumer computing device having one or more processors, a synchronous two-way electronic communication session with a vendor computing device, the consumer and vendor computing devices associated with a consumer and a vendor, respectively. The technique can include receiving, at the consumer computing device from the vendor computing device via the synchronous two-way electronic communication session, an offer to purchase a specific product associated with the vendor. The technique can include displaying, at the consumer computing device, the offer to purchase the specific product within the synchronous two-way electronic communication session. The technique can include receiving, at the consumer computing device, a selection of the offer from the consumer indicating an acceptance of the offer to purchase the specific product from the vendor. The technique can also include in response to receiving the selection of the offer, transmitting, from the consumer computing device: (i) purchase information to the vendor computing device, wherein receipt of the purchase information causes the vendor computing device to complete the sale of the specific product to the consumer, and (ii) authentication information to a third-party payment service, the authentication information being for an electronic wallet associated with the consumer and the third-party payment service, wherein receipt of the authentication information causes the third-party payment service to pay the vendor thereby completing the sale of the specific product to the consumer.

In some embodiments, the technique further includes in response to receiving the offer to purchase the specific product, receiving, at the consumer computing device, a question about the specific product within the synchronous two-way electronic communication session, and transmitting, from the consumer computing device to the vendor computing device via the synchronous two-way electronic communication session, the question about the specific product.

In some embodiments, the technique further includes receiving, at the consumer computing device from the vendor computing device via the synchronous two-way electronic communication session, an answer to the question about the specific product, and displaying, at the consumer computing device, the answer within the synchronous two-way electronic communication session.

In some embodiments, displaying the offer includes displaying at least one of (i) an image of the specific product and (ii) a text describing the specific product. In some embodiments, the offer includes a unique link configured to accept the offer to purchase the specific product when selected by the consumer.

In some embodiments, the technique further includes prompting, at the consumer computing device, the consumer to input the authentication information for the electronic wallet, and in response to receiving the authentication information from the user, transmitting, from the consumer computing device, the authentication information to the third-party payment service.

In some embodiments, the technique further includes receiving, at the consumer computing device from the consumer, a passive opt-in input indicative of a request to follow the vendor on a social network, and transmitting, from the consumer computing device to a server associated with the social network, the request, wherein receipt of the request causes the server to notify the vendor computing device that the consumer has opted-in to receiving offers for products associated with the vendor via the synchronous two-way electronic communication session, thereby causing the vendor computing device to: (i) initiate the synchronous two-way electronic communication session between the vendor computing device and the consumer computing device, and (ii) transmit the offer to purchase the specific product to the consumer computing device via the synchronous two-way electronic communication session.

In some embodiments, the techniques further include receiving, at the consumer computing device from the consumer, an explicit opt-in input indicative of an explicit request to receive offers for products associated with the vendor via the synchronous two-way electronic communication session, and transmitting, from the consumer computing device the vendor computing device, the explicit request, wherein receipt of the explicit request causes the vendor computing device to: (i) initiate the synchronous two-way electronic communication session between the vendor computing device and the consumer computing device, and (ii) transmit the offer to purchase the specific product to the consumer computing device via the synchronous two-way electronic communication session.

In some embodiments, the synchronous two-way electronic communication session is a real-time text chat session between the consumer and vendor computing devices. In other embodiments, the synchronous two-way electronic communication session is a text messaging session between the consumer and vendor computing devices.

Another computer-implemented technique is also presented. The technique can include receiving, at the consumer computing device having one or more processors, a passive opt-in input from a consumer associated with the consumer computing device, the passive opt-in input being indicative of a request to follow the vendor on a social network. The technique can include transmitting, from the consumer computing device to a server associated with the social network, the request, wherein receipt of the request causes the server to notify a vendor computing device associated with the vendor that the consumer has opted-in to receiving offers for products associated with the vendor. The technique can include in response to transmitting the request, joining, by the consumer computing device, a synchronous two-way electronic communication session with the vendor computing device. The technique can include receiving, at the consumer computing device from the vendor computing device via the synchronous two-way electronic communication session, an offer to purchase a specific product associated with the vendor. The technique can include displaying, at the consumer computing device, the offer to purchase the specific product within the synchronous two-way electronic communication session. The technique can include receiving, at the consumer computing device, an acceptance of the offer to purchase the specific product from the vendor. The technique can also include in response to receiving the acceptance, transmitting, from the consumer computing device, information to (i) the vendor computing device or (ii) a third-party payment service, wherein receipt of the information causes the purchase by the consumer of the specific product from the vendor to be completed.

In some embodiments, the technique can further include receiving, at the consumer computing device from the consumer, an explicit opt-in input indicative of an explicit request to receive offers for products associated with the vendor via the synchronous two-way electronic communication session, and transmitting, from the consumer computing device the vendor computing device, the explicit request, wherein receipt of the explicit request causes the vendor computing device to: (i) initiate the synchronous two-way electronic communication session between the vendor computing device and the consumer computing device, and (ii) transmit the offer to purchase the specific product to the consumer computing device via the synchronous two-way electronic communication session.

In some embodiments, the information is purchase information, wherein transmitting the information includes transmitting the purchase information to the vendor computing device, and wherein receipt of the purchase information causes the vendor computing device to complete the sale of the specific product to the consumer. In other embodiments, the information is authentication information for an electronic wallet associated with the consumer and a third-party payment service, wherein transmitting the information includes transmitting the authentication information to the third-party payment service, and wherein receipt of the authentication information causes the third-party payment service to pay the vendor thereby completing the sale of the specific product to the consumer.

In some embodiments, the technique further includes prompting, at the consumer computing device, the consumer to input the authentication information for their electronic wallet, and in response to receiving the authentication information from the user, transmitting, from the consumer computing device, the authentication information to the third-party service provider.

In some embodiments, displaying the offer includes displaying at least one of (i) an image of the specific product and (ii) a text describing the specific product. In some embodiments, the offer includes a unique link configured to accept the offer to purchase the specific product when selected by the consumer.

In some embodiments, the technique further includes in response to receiving the offer to purchase the specific product, receiving, at the consumer computing device, a question about the specific product within the synchronous two-way electronic communication session, transmitting, from the consumer computing device to the vendor computing device via the synchronous two-way electronic communication session, the question about the specific product, receiving, at the consumer computing device from the vendor computing device via the synchronous two-way electronic communication session, an answer to the question about the specific product, and displaying, at the consumer computing device, the answer within the synchronous two-way electronic communication session.

In some embodiments, the synchronous two-way electronic communication session is one of (i) a real-time text chat session between the consumer and vendor computing devices and (ii) a text messaging session between the consumer and vendor computing devices.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a diagram of a computing network including example computing devices according to some implementations of the present disclosure;

FIG. 2 is a functional block diagram of one of the example computing devices of FIG. 1;

FIG. 3 is a diagram of an example user interface according to some implementations of the present disclosure; and

FIGS. 4A-4B are flow diagrams of example techniques for selling and purchasing products via synchronous two-way electronic communication sessions according to some implementations of the present disclosure.

### DETAILED DESCRIPTION

As previously mentioned, conventional online shopping systems are difficult and/or time consuming for both the consumers (buyers) and the vendors (sellers). Accordingly, techniques for selling and purchasing products via synchronous two-way electronic communications are presented. The techniques provide for an easier and/or more efficient online shopping experience for both the consumers and the vendors. For example, the consumer may be able to purchase a product in one-click from their mobile device. The techniques can be initiated when a consumer provides opt-in information indicative of interest in a vendor. In one implementation, the opt-in information is explicit, such as the consumer providing their contact information in store or online due to their interest in the vendor or a specific product. In another implementation, the opt-in information is passive, such as the consumer following the vendor or a specific product on social media or the consumer having a browsing history indicative of the vendor or the specific product.

When this opt-in information is provided, an electronic communication session can be initiated between the consumer and the vendor, by which the vendor can provide an offer for a product to the consumer. In some implementations, the consumer could ask follow-up questions and directly interact with the vendor. In one implementation, the offer is a unique “link” that, when selected by the consumer, initiates a transaction to purchase the product. For example, selection of this unique link could initiate a payment via an electronic wallet of the consumer. In one implementation, selection of this unique link can initiate a “one-click” purchase by with a payment is automatically provided via the electronic wallet. In another implementation, the consumer may have to input a pin or code for their electronic wallet in order to complete the transaction. The purchase information (credit card number, shipping address, etc.) is then transmitted automatically to the vendor, who can complete the sale on their end.

In situations in which the systems discussed here collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how and whether information is collected about the user and used by a content server.

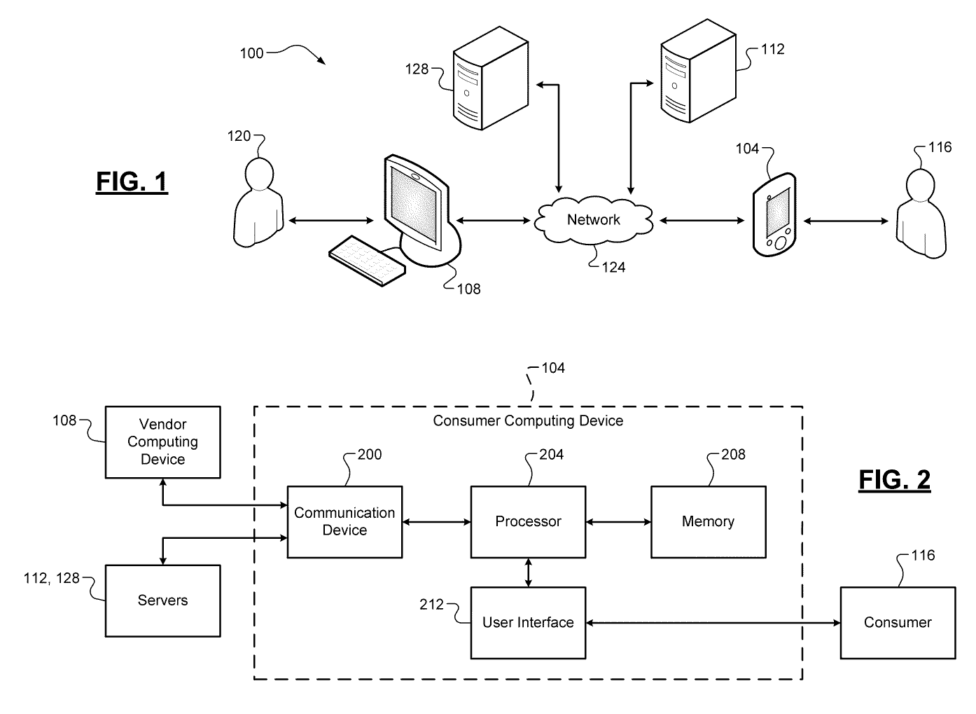

Referring now to FIG. 1, a diagram of a computing network 100 is illustrated. The computing network 100 can include example computing devices 104 and 108 according to some implementations of the present disclosure. Examples of the computing devices 104 and 108 include desktop computers, laptop computers, tablet computers, and mobile phones. Computing device 104 can be associated with a consumer user 116 (hereinafter “consumer 116”) and thus can be referred to as “consumer computing device 104.” Similarly, computing device 108 can be associated with a vendor user 120 (hereinafter “vendor 120”) and thus can be referred to as “vendor computing device 108.” For example, the consumer 104 may be a potential purchaser of a specific product or a specific type of product sold by the vendor 120. Examples of the vendor 120 include brick-and-mortar business, online businesses, and combinations thereof.

The computing network 100 can also include an example server 112 according to some implementations of the present disclosure. As used herein, the term “server” can refer to any suitable hardware computer server, as well as both a single server and multiple servers operating in a parallel or distributed architecture. In one implementation, the server 112 is associated with a social network. The consumer computing device 104, the vendor computing device 108, and the server 112 can communicate with each other via a network 124. The network 124 can be a local area network (LAN), a wide area network (WAN), e.g., the Internet, or a combination thereof. In one implementation, the consumer computing device 104 and the vendor computing device 108 can communicate with each other via a synchronous two-way electronic communication session over the network 124. The term “synchronous two-way electronic communication session” as used herein can refer to any direct, synchronous two-way electronic communication session between two computing devices.

Examples of the synchronous two-way electronic communication session include real-time text chat and text messaging, such as Short Message Service (SMS) text messaging, but not one-way electronic communication sessions, such as email. Provided the consumer 116 has opted-in, the consumer computing device 104 and the vendor computing device 108 can communicate via the synchronous two-way electronic communication session according to the techniques of the present disclosure. Specifically, the vendor computing device 108 can provide an offer to purchase a specific product, and the consumer computing device 104 can accept the offer, such as by a one-click purchase. The server 112 may be involved in the opt-in by the consumer 116, such as when the consumer 116 has followed the vendor 120 on the social network. In one implementation, a third-party payment service 128 (represented as a server) can also communicate with the consumer computing device 104 and the vendor computing device 108 as part of the purchase process.

Referring now to FIG. 2, a functional block diagram of the consumer computing device 104 is illustrated. While the consumer computing device 104 is illustrated and described herein, it should be appreciated that the vendor computing device 108 and the server 112 can each have the same or a similar architecture as the consumer computing device 104. The consumer computing device 104 can include a communication device 200, a processor 204, a memory 208, and a user interface 212. The communication device 200 can include any suitable components (e.g., a transceiver) for communication via the network 124. The memory 208 can be any suitable storage medium (flash, hard disk, etc.) for storing information at the consumer computing device 104.

The user interface 212 can include any suitable components (a touch display, a non-touch display, a physical keyboard, a mouse, a microphone, a speaker, etc.) for receiving input from the consumer 116 and for providing output (visual, audio, etc.) to the consumer 116. In one implementation, the user interface 212 includes a touch display that can display the offer to purchase the specific product to the consumer 116 and can receive the acceptance of the offer by the consumer 116. Examples of this acceptance can include selecting a unique link and providing authentication information for an electronic wallet. The processor 204 can control operation of the consumer computing device 104, including implementing at least a portion of the techniques of the present disclosure, which are described in greater detail below.

In one implementation, the consumer 116 must opt-in to receiving offers to purchase products from the vendor 120 or from vendors in general. The consumer 116 may passively opt-in or explicitly opt-in. The term “passive opt-in” as used herein refers to actions by the consumer 116 indicative of an interest in the vendor 120 or a specific product sold by the vendor 120. In one implementation, the passive opt-in by the consumer 116 can be determined based on their activity on the social network (i.e., at server 112). For example, the consumer 116 can be determined to have passively opted-in when the consumer 116 follows, likes, or otherwise indicates a preference for the vendor 120 or their specific product on the social network. In these cases, the server 112 can notify the vendor 120 that the consumer 116 has passively opted-in. For example, this notification may include additional contact information for the vendor 120 to utilize when contacting the consumer 116 about an offer. The passive opt-in could also be determined by the server 112 or another server based on other information about the consumer 116, such as their past search queries and/or browsing history.

Alternatively, the consumer 116 may explicitly opt-in. The term “explicit opt-in” as used herein can refer to any explicit actions by the consumer 116 requesting to receive offers from the vendor 120 or their specific product, or from vendors in general. One example explicit opt-in scenario is when the consumer 116 is visiting a brick and mortar store of the vendor 120 and the consumer 116 explicitly opts-in to receiving offers, such as by providing their information at a computing station or to a salesperson. Another example explicit opt-in scenario is when the consumer 116 is visiting a website of the vendor 120 and the consumer 116 explicitly opts-in to receiving offers, such as by selecting an option, creating an account, or the like. In these explicit opt-in scenarios, the vendor 120 should know that the consumer 116 has opted-in without notification from another party, such as the server 112.

If opting in is not required or the consumer 116 is determined to have opted-in, the vendor 120 can send an offer to purchase a specific product to the consumer 116. The vendor 120 can provide their offer by first initiating a synchronous two-way electronic communication session between their vendor computing device 108 and the consumer computing device 104. In some cases, however, the consumer 116 may initiate the synchronous two-way electronic communication session. Once the electronic communication session has been initiated, the vendor computing device 108 can transmit the offer to the consumer computing device 104. The consumer computing device 104 can then display the offer, which can be considered by the consumer 116. In some cases, the consumer 116 may have additional questions.

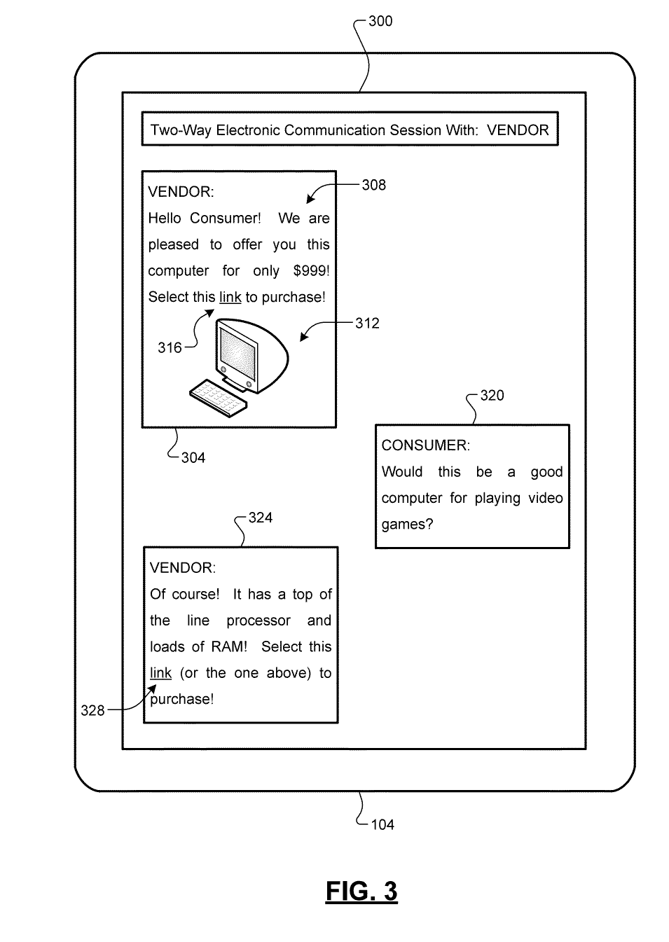

Referring now to FIG. 3 and with continued reference to FIG. 2, an example user interface 300 as viewed by the consumer 116 at the consumer computing device 104 (e.g., a display of the user interface 212) is illustrated. As illustrated, the vendor 120 has transmitted their offer 304 from their vendor computing device 108 to the consumer computing device 104. The offer 304 in the illustrated example is to purchase a specific computer. The offer 304 can include text 308 that describes the specific product and/or an image 312 of the specific product. The offer 304 can be configured to act as a unique link when selected (by mouse, touch display, etc.). In one implementation, the offer 304 can include a unique link 316 in the text 308. In another implementation, the offer 304 itself can be the unique link. Other configurations can also be utilized, such as making the image 312 the unique link. Selecting the unique link can initiate a purchase process (e.g., a one-click purchase process), which is described in greater detail below.

As previously mentioned, the consumer 116 may have additional questions. In the example synchronous two-way electronic communication session of FIG. 3, the consumer 116 has input and transmitted a follow-up question 320 from their consumer computing device 104 to the vendor computing device 108 via the synchronous two-way electronic communication session. In response, the vendor 120 has transmitted their answer 324 to the consumer computing device 104 from their vendor computing device 108 via the synchronous two-way electronic communication session. This answer 324 may include a unique link 328 in its text or may itself be a unique link. Additionally or alternatively, the consumer 116 may utilize the original offer 304 to access the unique link. This question/answer process can continue, such as until the consumer 116 decided whether or not to purchase the specific product.

Once the consumer 116 has selected the unique link, indicating their acceptance of the offer from the vendor 120, the purchase process can be initiated. In one implementation, the purchase process is a one-click purchase process. The term “one-click purchase process” as used herein can refer to the selection of the unique link causing the purchase process to complete without any additional intervention or action by the consumer 116. For example, the one-click purchase process may utilize an electronic wallet of the consumer 116. The electronic wallet 116 may be associated with the third-party payment service 128, which can pay the vendor 120 for the specific product on behalf of the consumer 116. In one implementation, authentication information is required by the third-party payment service 128. This authentication information can be automatically provided or could be input by the consumer 116 as part of the one-click purchase process. Alternatively, the one-click purchase process may include directly transmitting purchase information (credit card information, consumer's address, shipping address, etc.) to the vendor computing device 108.

Alternatively, the purchase process may not be a one-click purchase process, but may still be significantly easier and more efficient than conventional purchase processes. In response to a prompt at the consumer computing device 104, the consumer 116 may be required to input the authentication information (e.g., input a personal identification number, or PIN). After obtaining the authentication information, the consumer computing device 104 can transmit the authentication information to the third-party payment service 128. Alternatively, the consumer 116 may be required to input at least a portion of the purchase information for transmission directly to the vendor computing device 108. Once the vendor computing device 108 receives payment from the third-party payment service 128 or purchase information directly from the consumer computing device 104, the sale of the specific product to the consumer 116 can be completed.

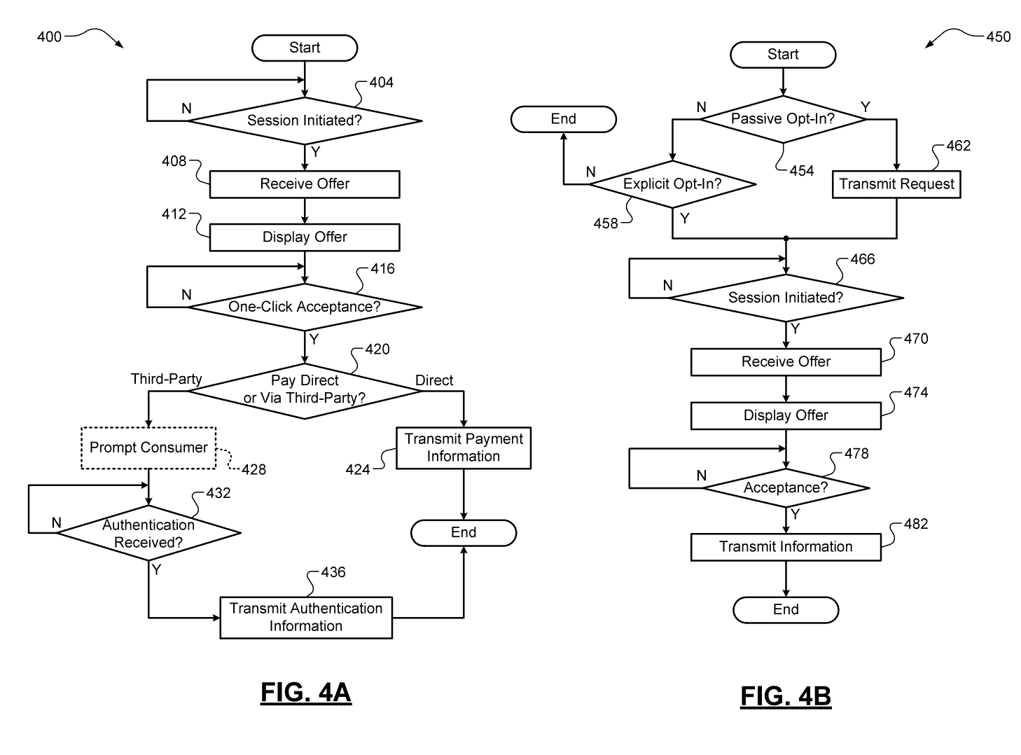

Referring now to FIGS. 4A-4B, flow diagrams of example techniques for purchasing and selling products via synchronous two-way electronic communications are illustrated.

FIG. 4A illustrates a first technique 400 for purchasing and selling products via synchronous two-way electronic communications and utilizing a third-party payment service. At 404, a synchronous two-way electronic communication session is initiated between the consumer computing device 104 and the vendor computing device 108. For example, the synchronous two-way electronic communication session may be initiated by the vendor computing device 108. Once the synchronous two-way electronic communication session is initiated, the technique 400 can proceed to 408. Otherwise, the technique 400 can end or return to 404. At 408, the consumer computing device 104 can receive, from the vendor computing device 108 via the synchronous two-way electronic communication session, an offer to purchase a specific product associated with the vendor 120. At 412, the consumer computing device 104 can display the offer to purchase the specific product within the synchronous two-way electronic communication session. For example, the offer may be displayed via the user interface 300 of FIG. 3. At 416, the consumer computing device 104 can receive a one-click input from the consumer 116 indicating an acceptance of the offer to purchase the specific product from the vendor 120. This one-click input can be received via the user interface 212. For example, the one-click input could be a single click of a mouse or a single touch or spot input to a touch display.

When the one-click input has been received, the technique 400 can proceed to 420. Otherwise, the technique 400 can end or return to 416. At 420, the consumer computing device 104 determine whether the consumer 116 is paying the vendor 120 directly or via the third-party payment service 128. When the consumer 116 is paying the vendor 120 directly, the consumer computing device 104 can transmit purchase information for the consumer 116 to the vendor computing device 108 at 424. The vendor computing device 108 can then complete the sale of the specific product to the consumer 116 using the purchase information and the technique 400 can end or return to 404. When the consumer 116 is paying the vendor 120 via the third-party payment service 128, the consumer computing device 104 can optionally prompt the consumer 116 to provide authentication information for his/her electronic wallet at 428. Alternatively, this authentication information can be stored at the memory 208 and the consumer 116 may have settings to automatically transmit the authentication information. After identifying receipt of the authentication information at 432, the consumer computing device 104 can transmit the authentication to the third-party payment service 128 at 436. The third-party payment service 128 can then pay the vendor 120 thereby completing the sale of the product to the consumer 116. The technique 400 can then end or return to 404.

FIG. 4B, on the other hand, illustrates a second technique 450 for selling and purchasing products via synchronous two-way electronic communications when the consumer 116 has passively opted-in. At 454, the consumer computing device 104 can receive a passive opt-in input from the consumer 116, the passive opt-in input being indicative of a request to follow the vendor 120 on a social network at the server 112. When the consumer 116 has passively opted-in, the technique 450 can proceed to 462. When the consumer 116 has not passively opted-in, a determination can be made at 458 as to whether the consumer 116 has explicitly opted-in, such as in-person at a store or via an explicit request online. When the consumer 116 has not explicitly opted-in, the technique 450 can end or return to 454. When the consumer 116 has explicitly opted-in, the technique 450 can proceed to 466. At 462, the consumer computing device 104 can transmit the request to the server 112, which can cause the server 112 to notify the vendor computing device 108 that the consumer 116 has opted-in to receiving offers for products associated with the vendor 120. At 466, a synchronous two-way electronic communication session can be initiated between the consumer computing device 104 and the vendor computing device 108. For example, the vendor computing device 108 may initiate the synchronous two-way electronic communication session, such as in response to receiving the notification from the server 112 or previously receiving the explicit opt-in from the consumer 116.

Once the synchronous two-way electronic communication session has been initiated, the technique 450 can proceed to 470. Otherwise, the technique 450 can end or return to 466. At 470, the consumer computing device 104 can receive, from the vendor computing device 108 via the synchronous two-way electronic communication session, an offer to purchase a specific product associated with the vendor 120. At 474, the consumer computing device 104 can display the offer to purchase the specific product within the synchronous two-way electronic communication session. For example, the offer may be displayed via the user interface 300 of FIG. 3. At 478, the consumer computing device 104 can receive an acceptance by the consumer 116 of the offer to purchase the specific product from the vendor 120. In one implementation, the acceptance can be a one-click acceptance to initiate the purchase process. When the offer has been accepted, the technique 450 can proceed to 482. Otherwise, the technique 450 can end or return to 478. At 482, the consumer computing device 104 can transmit information to (i) the vendor computing device or (ii) a third-party payment service, wherein receipt of the information causes the purchase by the consumer 116 of the specific product from the vendor 120 to be completed. For example, this information can be purchase information for the vendor 120 or authentication information for an electronic wallet and the third-party payment service 128. The technique 450 can then end or return to 454.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known procedures, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The term “and/or” includes any and all combinations of one or more of the associated listed items. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

As used herein, the term module may refer to, be part of, or include an Application Specific Integrated Circuit (ASIC); an electronic circuit; a combinational logic circuit; a field programmable gate array (FPGA); a processor (shared, dedicated, or group) that executes code, or a process executed by a distributed network of processors and storage in networked clusters or datacenters; other suitable components that provide the described functionality; or a combination of some or all of the above, such as in a system-on-chip. The term module may include memory (shared, dedicated, or group) that stores code executed by the one or more processors.

The term code, as used above, may include software, firmware, byte-code and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The techniques described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Some portions of the above description present the techniques described herein in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the described techniques include process steps and instructions described herein in the form of an algorithm. It should be noted that the described process steps and instructions could be embodied in software, firmware or hardware, and when embodied in software, could be downloaded to reside on and be operated from different platforms used by real time network operating systems.

The present disclosure also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a tangible computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatuses to perform the required method steps. The required structure for a variety of these systems will be apparent to those of skill in the art, along with equivalent variations. In addition, the present disclosure is not described with reference to any particular programming language. It is appreciated that a variety of programming languages may be used to implement the teachings of the present disclosure as described herein, and any references to specific languages are provided for disclosure of enablement and best mode of the present invention.

The present disclosure is well suited to a wide variety of computer network systems over numerous topologies. Within this field, the configuration and management of large networks comprise storage devices and computers that are communicatively coupled to dissimilar computers and storage devices over a network, such as the Internet.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method, comprising:
receiving, at a consumer computing device having one or more processors, an input from a consumer associated with the consumer computing device, the input being indicative of a request to follow a vendor on a social network;
transmitting, from the consumer computing device to a server associated with the social network, the request, wherein receipt of the request causes the server to notify a vendor computing device associated with the vendor that the consumer has opted-in to receiving offers for products associated with the vendor via a synchronous two-way electronic communication session;
joining, by the consumer computing device, the synchronous two-way electronic communication session with the vendor computing device;
receiving, at the consumer computing device from the vendor computing device via the synchronous two-way electronic communication session, an offer to purchase a specific product associated with the vendor;
displaying, at the consumer computing device, the offer to purchase the specific product within the synchronous two-way electronic communication session;
receiving, at the consumer computing device, a one-click input from the consumer indicating an acceptance of the offer to purchase the specific product from the vendor; and
in response to receiving the one-click input, transmitting, from the consumer computing device to a third-party payment service, purchase information for the consumer, wherein receipt of the purchase information at the third-party payment service causes the third-party payment service to pay the vendor thereby completing the sale of the specific product to the consumer.

2. A computer implemented method, comprising:
joining, by a consumer computing device having one or more processors, a synchronous two-way electronic communication session with a vendor computing device, the consumer and vendor computing devices associated with a consumer and a vendor, respectively;
receiving, at the consumer computing device from the vendor computing device via the synchronous two-way electronic communication session, an offer to purchase a specific product associated with the vendor;
displaying, at the consumer computing device, the offer to purchase the specific product within the synchronous two-way electronic communication session;
receiving, at the consumer computing device, a selection of the offer from the consumer indicating an acceptance of the offer to purchase the specific product from the vendor; and
in response to receiving the selection of the offer, transmitting, from the consumer computing device:
(i) purchase information to the vendor computing device, wherein receipt of the purchase information causes the vendor computing device to complete the sale of the specific product to the consumer; and
(ii) authentication information to a third-party payment service, the authentication information being for an electronic wallet associated with the consumer and the third-party payment service, wherein receipt of the authentication information causes the third-party payment service to pay the vendor thereby completing the sale of the specific product to the consumer.

3. The computer-implemented method of claim 2, further comprising:
in response to receiving the offer to purchase the specific product, receiving, at the consumer computing device, a question about the specific product within the synchronous two-way electronic communication session; and
transmitting, from the consumer computing device to the vendor computing device via the synchronous two-way electronic communication session, the question about the specific product.

4. The computer-implemented method of claim 3, further comprising:
receiving, at the consumer computing device from the vendor computing device via the synchronous two-way electronic communication session, an answer to the question about the specific product; and
displaying, at the consumer computing device, the answer within the synchronous two-way electronic communication session.

5. The computer-implemented method of claim 2, wherein displaying the offer includes displaying at least one of (i) an image of the specific product and (ii) a text describing the specific product.

6. The computer-implemented method of claim 2, wherein the offer includes a unique link configured to accept the offer to purchase the specific product when selected by the consumer.

7. The computer-implemented method of claim 2, further comprising:
prompting, at the consumer computing device, the consumer to input the authentication information for the electronic wallet; and
in response to receiving the authentication information from the user, transmitting, from the consumer computing device, the authentication information to the third-party payment service.

8. The computer-implemented method of claim 2, further comprising:
receiving, at the consumer computing device from the consumer, a passive opt-in input indicative of a request to follow the vendor on a social network; and
transmitting, from the consumer computing device to a server associated with the social network, the request, wherein receipt of the request causes the server to notify the vendor computing device that the consumer has opted-in to receiving offers for products associated with the vendor via the synchronous two-way electronic communication session, thereby causing the vendor computing device to:
(i) initiate the synchronous two-way electronic communication session between the vendor computing device and the consumer computing device; and
(ii) transmit the offer to purchase the specific product to the consumer computing device via the synchronous two-way electronic communication session.

9. The computer-implemented method of claim 2, further comprising:
receiving, at the consumer computing device from the consumer, an explicit opt-in input indicative of an explicit request to receive offers for products associated with the vendor via the synchronous two-way electronic communication session; and
transmitting, from the consumer computing device the vendor computing device, the explicit request, wherein receipt of the explicit request causes the vendor computing device to:
(i) initiate the synchronous two-way electronic communication session between the vendor computing device and the consumer computing device; and
(ii) transmit the offer to purchase the specific product to the consumer computing device via the synchronous two-way electronic communication session.

10. The computer-implemented method of claim 2, wherein the synchronous two-way electronic communication session is a real-time text chat session between the consumer and vendor computing devices.

11. The computer-implemented method of claim 2, wherein the synchronous two-way electronic communication session is a text messaging session between the consumer and vendor computing devices.

12. A computer-implemented method, comprising:
receiving, at the consumer computing device having one or more processors, a passive opt-in input from a consumer associated with the consumer computing device, the passive opt-in input being indicative of a request to follow the vendor on a social network;
transmitting, from the consumer computing device to a server associated with the social network, the request, wherein receipt of the request causes the server to notify a vendor computing device associated with the vendor that the consumer has opted-in to receiving offers for products associated with the vendor;
in response to transmitting the request, joining, by the consumer computing device, a synchronous two-way electronic communication session with the vendor computing device;
receiving, at the consumer computing device from the vendor computing device via the synchronous two-way electronic communication session, an offer to purchase a specific product associated with the vendor;
displaying, at the consumer computing device, the offer to purchase the specific product within the synchronous two-way electronic communication session;
receiving, at the consumer computing device, an acceptance of the offer to purchase the specific product from the vendor; and
in response to receiving the acceptance, transmitting, from the consumer computing device, information to (i) the vendor computing device or (ii) a third-party payment service, wherein receipt of the information causes the purchase by the consumer of the specific product from the vendor to be completed.

13. The computer-implemented method of claim 12, further comprising:
receiving, at the consumer computing device from the consumer, an explicit opt-in input indicative of an explicit request to receive offers for products associated with the vendor via the synchronous two-way electronic communication session; and
transmitting, from the consumer computing device the vendor computing device, the explicit request, wherein receipt of the explicit request causes the vendor computing device to:
(i) initiate the synchronous two-way electronic communication session between the vendor computing device and the consumer computing device; and
(ii) transmit the offer to purchase the specific product to the consumer computing device via the synchronous two-way electronic communication session.

14. The computer-implemented method of claim 12, wherein the information is purchase information, wherein transmitting the information includes transmitting the purchase information to the vendor computing device, and wherein receipt of the purchase information causes the vendor computing device to complete the sale of the specific product to the consumer.

15. The computer-implemented method of claim 12, wherein the information is authentication information for an electronic wallet associated with the consumer and a third-party payment service, wherein transmitting the information includes transmitting the authentication information to the third-party payment service, and wherein receipt of the authentication information causes the third-party payment service to pay the vendor thereby completing the sale of the specific product to the consumer.

16. The computer-implemented method of claim 15, further comprising:
prompting, at the consumer computing device, the consumer to input the authentication information for their electronic wallet; and
in response to receiving the authentication information from the user, transmitting, from the consumer computing device, the authentication information to the third-party service provider.

17. The computer-implemented method of claim 12, wherein displaying the offer includes displaying at least one of (i) an image of the specific product and (ii) a text describing the specific product.

18. The computer-implemented method of claim 12, wherein the offer includes a unique link configured to accept the offer to purchase the specific product when selected by the consumer.

19. The computer-implemented method of claim 12, further comprising:
in response to receiving the offer to purchase the specific product, receiving, at the consumer computing device, a question about the specific product within the synchronous two-way electronic communication session;
transmitting, from the consumer computing device to the vendor computing device via the synchronous two-way electronic communication session, the question about the specific product;
receiving, at the consumer computing device from the vendor computing device via the synchronous two-way electronic communication session, an answer to the question about the specific product; and
displaying, at the consumer computing device, the answer within the synchronous two-way electronic communication session.

20. The computer-implemented method of claim 12, wherein the synchronous two-way electronic communication session is one of (i) a real-time text chat session between the consumer and vendor computing devices and (ii) a text messaging session between the consumer and vendor computing devices.
